(19) United States
(12) Patent Application Publication
(10) Pub. No.: US 2009/0105936 A1
(43) Pub. Date: Apr. 23, 2009

(54) ROUTE GUIDANCE APPARATUS, ROUTE GUIDANCE METHOD, ROUTE GUIDANCE PROGRAM AND COMPUTER-READABLE RECORDING MEDIUM

(76) Inventor: Hiroaki Shibasaki, Tokyo (JP)

Correspondence Address: YOUNG & THOMPSON, 209 Madison Street, Suite 500, ALEXANDRIA, VA, 22314, US

(21) Appl. No.: 12/297,708

(22) PCT Filed: Apr. 18, 2007
(86) PCT No.: PCT/JP2007/058452

§ 371 Date: Oct. 20, 2008

(30) Foreign Application Priority Data
Apr. 20, 2006 (JP) 2006-116835

(51) Int. Cl. G01C 21/00

(52) U.S. Cl. 701/200; 701/207

(57) ABSTRACT

A route guidance apparatus includes a detecting unit that detects from an set route a left/right-turn point that a vehicle has not passed; a searching unit that searches for an alternative route before the vehicle passes the left/right-turn point in case the vehicle misses the turn at the left/right-turn point; a computing unit that computes cost information concerning the alternative route and cost information concerning a direct route on the set route from the left/right-turn point to a merging point where the set route meets the alternative route; a determining unit that determines a degree of importance of the left/right-turn point based on the cost information; and an output unit that outputs, before the mobile object passes the left/right-turn point, alarm information that concerns the left/right-turn point and is based on the degree of importance determined.

### TECHNICAL FIELD

The present invention pertains to a route guidance apparatus, a route guidance method, a route guidance program and a computer-readable recording medium that are mounted on a mobile object and guide the mobile object. However, applications of this invention are not limited to a route guidance apparatus, a route guidance method, a route guidance program and a computer-readable recording medium that are mounted on a mobile object and guide the mobile object.

### BACKGROUND ART

One conventional route guidance apparatus, in providing route guidance to a destination, outputs guidance information indicating that a driver of a mobile object should take a left or right at a point, before the mobile object passes the point. Further, an alternative path to a destination is searched for beforehand lest the mobile object fails to take a left or right (see Patent Document 1).

### DISCLOSURE OF INVENTION

### Problem to be Solved by the Invention

However, left/right-turn points may include such a significant point that if the mobile object fails to turn left or right, the mobile object must take a long detour. The conventional technique does not distinguish such a point and only outputs the same guidance information as for other points. One example of a resulting problem is that a driver does not know which point on a route to especially pay attention to. The driver may feel nervous at all left/right-turn points, or may not be careful enough to pay attention at the significant point and be forced to take a long detour when failing to take a left or right.

### Means for Solving Problem

A route guidance apparatus according to the invention of claim 1 includes a detecting unit that detects from a set route, a left/right-turn point that a vehicle has not passed; a searching unit that searches for an alternative route before the vehicle passes the left/right-turn point in case the vehicle does not turn at the left/right-turn point; a computing unit that computes cost information concerning the alternative route and cost information concerning a direct route on the set route from the left/right-turn point to a merging point where the set route and the alternative route meet; a determining unit that determines a degree of importance of the left/right-turn point based on the cost information computed by the computing unit; and an output unit that based on the degree of importance determined by the determining unit, outputs alarm information before the mobile object passes the left/right-turn point, the alarm information concerning the left/right-turn point.

A route guidance method according to the invention of claim 5 includes a detecting step of detecting from a set route, a left/right-turn point that a vehicle has not passed; a searching step of searching for an alternative route before the vehicle passes the left/right-turn point in case the vehicle does not turn at the left/right-turn point; a computing step of computing cost information concerning the alternative route and cost information concerning a direct route on the set route from the left/right-turn point to a merging point where the set route and the alternative route meet; a determining step of determining a degree of importance of the left/right-turn point based on the cost information computed at the computing step; and an output step of outputting based on the degree of importance determined by the determining unit, alarm information before the mobile object passes the left/right-turn point, the alarm information concerning the left/right-turn point.

A route-guidance computer program according to the invention of claim 9 causes a computer to execute the route guidance method according to any one of claims 5 to 8.

A computer-readable recording medium according to the invention of claim 10 stores therein the route-guidance computer program according to claim 9.

A route guidance apparatus according to the invention of claim 11 includes a detecting unit that detects from a set route, a given point that a vehicle has not passed; a searching unit that searches for an alternative route before the vehicle passes the given point in case the vehicle does not pass the given point according to the set route; a computing unit that computes cost information concerning the alternative route; and an output unit that outputs, based on the cost information computed by the computing unit, alarm information concerning the given point before the mobile object passes the given point.

A route guidance method according to the invention of claim 12 includes a detecting step of detecting from a set route, a given point that a vehicle has not passed; a searching step of searching for an alternative route before the vehicle passes the given point in case the vehicle does not pass the given point according to the set route; a computing step of computing cost information concerning the alternative route; and an output step of outputting, based on the cost information computed by the computing unit, alarm information concerning the given point before the mobile object passes the given point.

### BRIEF DESCRIPTION OF DRAWINGS

FIG. 1 is a block diagram depicting a functional configuration of a route guidance apparatus according to an embodiment;

FIG. 2 is a flowchart of a route guidance process of the route guidance apparatus according to the embodiment;

FIG. 3 is a block diagram of a hardware configuration of the navigation apparatus;

FIG. 4 is a diagram depicting one example of a situation where a vehicle equipped with a navigation apparatus according to the exemplary embodiment is traveling on the set route;

FIG. 5 is a flowchart of one example of the route navigation process of the navigation apparatus; and

FIG. 6 is a diagram depicting a situation where the navigation apparatus outputs advisory information concerning a left/right turn and alarm information to the display.

### EXPLANATIONS OF LETTERS OR NUMERALS

100 Route guidance apparatus
101 Detecting unit
102 Searching unit
103 Computing unit
104 Determining unit
105 Output unit
106 Measuring unit
107 Left/right-turn judging unit
108 Identifying unit
400 Vehicle

### BEST MODE(S) FOR CARRYING OUT THE INVENTION

With reference to the drawings, exemplary embodiments for a route guidance apparatus, a route guidance method, a route guidance program and a computer-readable recording medium are explained in detail.

(Functional Configuration of Route Guidance Apparatus)

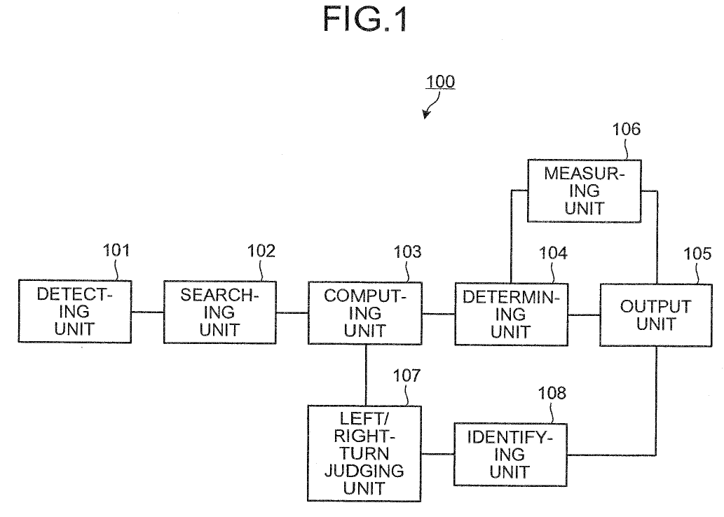

A functional configuration of a route guidance apparatus in this exemplary embodiment of the present invention is explained. FIG. 1 is a block diagram depicting a functional configuration of a route guidance apparatus according to an embodiment. As shown in FIG. 1, a route guidance apparatus includes a detecting unit 101, a searching unit 102, a computing unit 103, a determining unit 104, an output unit 105, a measuring unit 106, a left/right-turn judging unit 107, and an identifying unit 108.

The detecting unit 101 detects on a set route, a left/right-turn point that a mobile object has not yet passed. The set route is a route that is set by a user operation or by a route setting unit (not shown) and that the mobile object follows from a starting point to a destination. The mobile object is, for example, a vehicle (including a four-wheel vehicle, a two-wheel vehicle).

The left/right-turn point indicates a branching point on a route such as a junction, a T-junction, and a Y-junction where the mobile object turns left or right. A left/right-turn point that a mobile object has not yet passed indicates a point that the mobile object has not yet passed where the vehicle should turn left or right. The left/right-turn point is an example of a given point described in the CLAIMS. The given point is not limited to the left/right-turn point and may include a point at which the mobile object could stray from the set route even if going along a road; namely, a point en route where the driver should be careful in order to keep the mobile object on the set route. The given point includes all points within the scope of the present invention.

The searching unit 102 searches for an alternative route before the mobile object passes a left/right-turn point detected by the detecting unit 101 in case the mobile object misses the turn at the left/right-turn point. As an alternative route is searched for before the mobile object passes through the left/right-turn point, route guidance is performed taking into account the cost of the alternative route if the driver misses the turn. When the mobile object misses the turn at the left/right-turn point, for example, is when the mobile object goes straight or turns left at a point where the mobile object should turn right according to the set route, or goes straight or turns right at a point where the mobile object should turn left according to the set route.

The alternative route is a route that is newly set when the mobile object strays from the originally set route missing the turn contrary to the originally set route. The alternative route is usually one but multiple alternative routes may be searched for. The phrase “before the mobile object passes the left/right-turn point” is indicative of a time interval between detection of the left/right turn point by the detecting unit 101 and passage of the mobile object through the left/right-turn point.

Further, the phrase “before the mobile object passes the left/right-turn point” may be, for example, just after the detecting unit 101 detects the left/right turn point, may be when the mobile object passes through a point at a predetermined distance before (100 m for example) the left/right-turn point, or may be just before the mobile object passes through a left/right-turn point that the mobile object possibly reaches within a predetermined time (20 seconds before, for example).

The computing unit 103 outputs cost information concerning an alternative route and cost information concerning a direct route that is part of the set route from the left/right-turn point to a merging point where the alternative route and the set route meet. The direct route indicates a route from a left/right-turn point to the merging point when the mobile object correctly turns left or right according to the set route. The computing unit 103 may only output cost information concerning an alternative route without outputting cost information concerning the direct route.

The cost information concerning a route is information concerning the cost incurred when the mobile object travels along the route. The cost information includes, for example, the length of the route, estimated time required to travel along the route, and/or tolls for the route. The cost information concerning the route may include accident information or congestion information. The accident information and the congestion information can be obtained, for example, from a network via a communication unit (not shown).

The cost information concerning an alternative route is information concerning the cost for the alternative route from a point where the mobile object misses the turn contrary to the set route to a point where the alternative route merges into the set route. The cost information concerning a direct route that is part of the set route from the left/right-turn point to the merging point is cost information concerning a route when the mobile object correctly turns left or right as indicated by the set route and travels along the set route to the merging point. The merging of a set route and an alternative route includes the set route and the alternative route merging for the first time at a destination.

When the left/right-turn judging unit 107 judges that the mobile object has missed a turn, the computing unit 103 further computes, based on a current position identified by the identifying unit 108, cost information concerning part of the alternative route from the current position to the merging point, and cost information concerning a returning route on the alternative route from the current position to the left/right-turn point.

The determining unit 104 determines a degree of importance of the left/right-turn point based on the cost information computed by the computing unit 103. For example, when an alternative route is retrieved by the searching unit 102, the determining unit 104 computes the difference between the cost for the alternative route and the cost for the direct route on the set route from the left/right-turn point to the merging point. The determining unit 104 determines that if the difference is more than or equal to a given value, the degree of importance is “high”, and if the difference is less than the given value, the degree of importance is “normal”.

When the searching unit 102 retrieves multiple alternative routes, the determining unit 104 computes differences between the direct route of the set route from the left/right-turn point to a merging point and the alternative routes, and selects one alternative route that yields the smallest cost difference. The determining unit 104 determines that if the cost difference for the selected alternative route is more than or equal to a given value, the degree of importance is “high” and if the cost difference is less than the given value, the degree of importance is “normal”. The given value may be multiple values to divide the degree of importance into three or more levels such as “high”, “middle”, “normal” or the degree of importance may be represented by numerals based on the cost difference. The determining unit 104 may determine the degree of importance based only on the cost of the alternative route. In this case, the determining unit 104 determines that the degree of importance is “high” if, for example, the alternative route includes a toll road. As another example, when the set route includes a toll road and the mobile object is forced to travel on a general road as an alternative way to a destination once the mobile object strays from the set route resulting in the mobile object never reaching the toll road, the degree of importance may be set particularly high because the cost difference becomes prominent (especially the cost difference in terms of time becomes large). The degree of importance may be set particularly high when a difference concerning a fee-related cost becomes large.

When the degree of importance is determined, information concerning an index of driving ease such as the width of road, the number of curves or the number of meandering zones, compared with the set route, may be taken into account. The information concerning driving ease may be stored, for example, in a storing unit (not shown) or may be obtained from a network via a communication unit (not shown). The information concerning driving ease may be converted into cost of a route based on a predetermined conversion table and added into cost of the set route and the alternative route so that the information concerning driving ease is considered when determining the degree of importance. When a ramp of a highway or freeway, a bridge, or a crossing exists on an alternative route, the degree of importance may be set “high”.

When the mobile object does not turn left or right as indicated by the set route, the determining unit 104 determines a route from the current position to the merging point based on cost information for an alternative route computed by the computing unit 103 and information concerning the total cost, namely cost information for a returning route and cost information for the direct route.

More specifically, the determining unit 104 compares the cost for the alternative route with the sum of the cost for the returning route and the cost for the direct route. When the cost for the alternative route is smaller, the determining unit 104 chooses the alternative route as a route to the merging point. When the cost for the alternative route is larger, the determining unit 104 chooses, as a route to the merging point, the returning route back to the left/right-turn point and the direct route to the merging point.

In other words, the determining unit 104 determines whether to go back to the left/right-turn point, comparing the cost for a route retuning from the current position to the left/right-turn point where the mobile object missed a turn and a route on the set route ending at the merging point with the cost for a route on the alternative route from the current position to the merging point without returning to the left/right-turn point.

The output unit 105 outputs alarm information concerning the left/right-turn point, based on the degree of importance determined by the determining unit 104 and before the mobile object passes through the left/right-turn point. The alarm information concerning the left/right-turn point indicates information that advises a user to be careful to make a left/right turn in accordance with the set route. For example, if the degree of importance of the next left/right-turn point is determined to be “high” by the determining unit 104, the output unit 105 outputs, by an image or sound, information indicating that the driver must be especially careful to make a left/right turn in accordance with the set route.

The output unit 105 may output the difference between the cost of the alternative route and the cost of the set route when the degree of importance of the next left/right-turn point is determined to be “high”. In other words, in this case the output unit 105 outputs information concerning how many minutes arrival at the destination will be delayed (how many meters an additional detour will be) when the mobile object does not turn left/right in accordance with the set route compared with a case where the mobile object makes a correct turn. The difference concerning cost may be output irrespective of the degree of importance of the left/right-turn point. The route guidance apparatus 100 may be configured such that the output unit 105 outputs the difference concerning cost without determination of the degree of importance by the determining unit 104.

When the degree of importance of the next left/right-turn point is determined to be “high” by the determining unit 104, the output unit 105 may increase the number of alarms more than normal or may change the display color of the alarm to indicate that the driver must make a left/right turn at the left/right-turn point.

When the degree of importance of the left/right-turn point determined by the determining unit 104 is equal to or more than a given value, the output unit 105 may output alarm information concerning the left/right-turn point before the mobile object passes through the left/right-turn point.

When the degree of importance of the left/right-turn point is more than or equal to a given value, and a velocity measured by the measuring unit 106 exceeds a given velocity, the output unit 105 outputs alarm information indicating that the driver should slow down. When a velocity exceeds a given velocity is, for example, when a velocity of the mobile object exceeds 80 km/h at a point 50 m before the left/right-turn point. The alarm information indicating that the driver should slow down is such alarm information indicating that the driver should slow down and be prepared to turn left/right at the left/right-turn point in accordance with the set route.

When the mobile object does not turn left/right contrary to the set route, the output unit 105, based on the determination result by the determining unit 104, outputs advisory information indicating whether the mobile object should go back to the left/right-turn point. The advisory information indicating whether to go back to the left/right-turn point is information indicating whether the mobile object should take the alternative route to the destination or go back to the left/right-turn point and follow the set route to the destination.

The measuring unit 106 measures a velocity of the mobile object prior to the left/right-turn point if the degree of importance determined by the determining unit 104 is more than or equal to a given value. The degree of importance being more than or equal to a given value is a case, for example, where the degree of importance determined by the determining unit 104 is “high”. The velocity of the mobile object indicates how fast the mobile object is moving when the mobile object is for example a vehicle. The phrase “before the left/right-turn point” indicates for example when the mobile object passes a point 100 m before the left/right-turn point.

The left/right-turn judging unit 107 judges whether the mobile object has turned left/right at the left/right-turn point as indicated by the set route. For example, the left/right-turn judging unit 107 judges whether the mobile object has turned right, left or has gone straight at a point where the mobile object should have turned right. The identifying unit 108 identifies the current position of the mobile object when the left/right-turn judging unit 107 judges that the mobile object has missed the turn.

(Route Guidance Process of Route Guidance Apparatus)

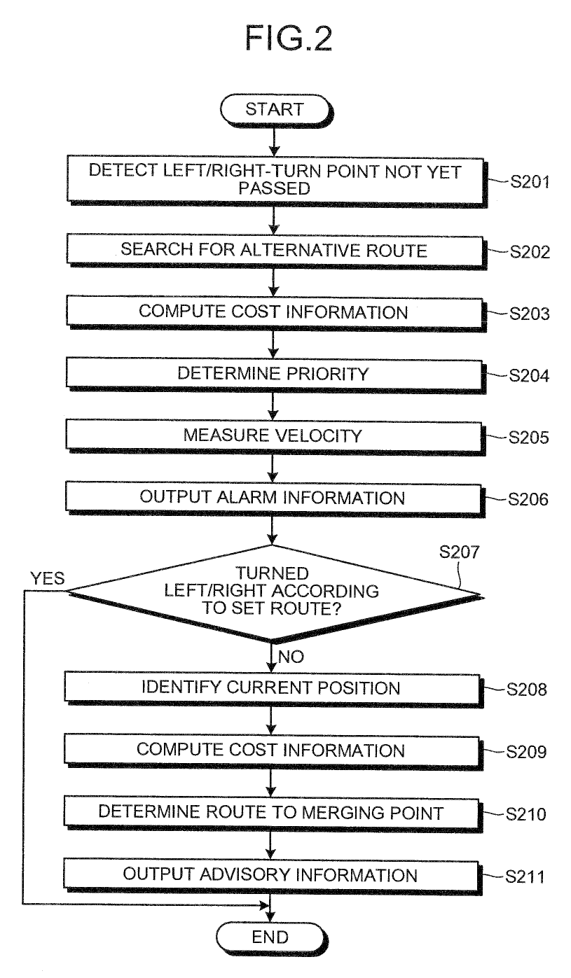

A route guidance process of the route guidance apparatus 100 of this exemplary embodiment is explained. FIG. 2 is a flowchart of a route guidance process of the route guidance apparatus according to the embodiment. As shown in FIG. 2, the detecting unit 101 detects a left/right-turn point that a mobile object has not passed through (step S201).

The searching unit 102 searches for, before the mobile object passes through the left/right-turn point, an alternative route in preparation for a case where the mobile object misses the turn at the left/right-turn point detected at step S201 (step S202). The computing unit 103 computes the cost for the alternative route and the cost for a direct route on a set route between the left-right turn point and a merging point of the two routes (step S203).

The determining unit 104 determines the degree of importance of the left/right-turn point based on the cost information obtained at step S203 (step S204). If the degree of importance determined at step S204 is more than or equal to a given value, the measuring unit 106 measures the velocity of the mobile object before the mobile object passes the left/right-turn point (step S205). If the velocity of the mobile object measured at step S205 exceeds a given velocity, the output unit 105 outputs, before the mobile object passes through the left/right-turn point, an alarm that the mobile object should reduce speed (step S206).

The left/right-turn judging unit 107 judges whether the mobile object has turned as indicated by the set route (step S207). If it is judged that the mobile object has correctly turned left or right (step S207: YES), the process is terminated. If it is judged that the mobile object has missed the turn (step S207: NO), the identifying unit 108 identifies the current position of the mobile object (step S208). The computing unit 103 computes the cost for a route of the alternative route from the current position to the merging point and the cost for a route of the alternative route returning to the left/right-turn point (step S209).

The determining unit 104 determines a route from the current position to the merging point based on the cost information concerning the alternative route computed at step S203 and based on the sum of the cost information concerning the returning route computed at step S205 and the cost information concerning the direct route (step S210). Advisory information based on the result at step S210 and indicating whether to return to the left/right-turn point is output (step S211), and the process is terminated.

According to the exemplary embodiment described above, importance of the left/right-turn point on a route is determined before the mobile object passes the left/right-turn point so that an alarm concerning that point can be output based on the importance. As a result, the driver drives carefully at a left/right-turn point having a high degree of importance.

Further, if the degree of importance of the next left/right-turn point is equal to or higher than a given value, the velocity of the mobile object is measured. If the velocity exceeds a given velocity, an alarm advising the driver to slow down may be output. As a result, even if the driver has forgotten about the turn, or slowed down late making a wrong estimation of distance to the left/right-turn point, alarm information is output so that the driver slows down and is given enough time to make the turn.

Furthermore, if the mobile object misses the turn, advisory information indicating whether to go back can be output. A user can be given information useful in deciding whether the user should go back to the left/right-turn point or take the alternative route.

Step S205 may be omitted. At step S206, instead of the alarm concerning the reduction of speed, an alarm concerning left/right-turn points may be output.

In this exemplary embodiment, a process for passing through a left/right-turn point as one example of a given point was explained. However, other examples of a given point described above are also applicable.

Hereinafter, one example of the route guidance apparatus 100 is explained. In this example, the route guidance apparatus 100 is applied to a navigation apparatus that is mounted on a mobile object such as a vehicle (including a four-wheel vehicle and a two-wheel vehicle).

(Hardware Configuration of Navigation Apparatus)

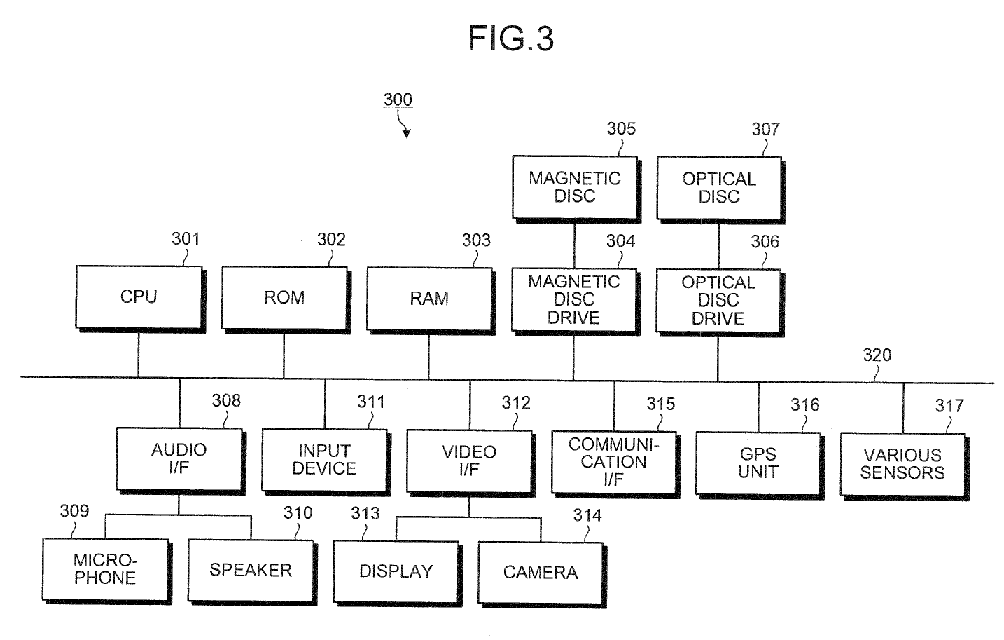

A hardware configuration is described for a navigation apparatus according to one example of the present invention. FIG. 3 is a block diagram of a hardware configuration of the navigation apparatus.

As shown in FIG. 3, a navigation apparatus 300, mounted on a mobile object such as a vehicle, includes a CPU 301, a ROM 302, a RAM 303, a magnetic disc drive 304, a magnetic disc 305, an optical disc drive 306, an optical disc 307, an audio I/F (interface) 308, a microphone 309, a speaker 310, an input device 311, a video I/F (interface) 312, a display 313, a camera 314, a communication I/F (interface) 315, a GPS unit 316, and various sensors 317. The constituent units 301-317 are connected through a bus 320.

The CPU 301 governs overall control of the navigation apparatus 300. The ROM 302 stores therein various programs such as a boot program, a current position identifying program, a route retrieval program, a route guidance program, a sound generation program, a map information display program, a communication program, a database generation program, a data analysis program. The RAM 303 is used as a working area of the CPU 301.

The current position identifying program causes the navigation apparatus to identify a current position of the vehicle (the current position of the navigation apparatus 300) based on the information output from the GPS unit 316 and the various sensors 317 which are described later.

The route retrieval program causes the navigation apparatus to retrieve an optimum route from a starting point to a destination or an alternative route when the vehicle strays from the optimum route, using map information stored in the magnetic disc 305 or the optical disc 307 which is described later. The optimum route is a route to the destination with the least cost or a route most satisfying conditions specified by the user. A route retrieved by the execution of the route guidance program is output to the audio I/F 308 or the video I/F 312 through the CPU 301.

The route guidance program causes the navigation apparatus to generate real-time route guidance information based on guide route information retrieved by the execution of the route guidance program, position information indicating the current position of the vehicle identified by the execution of the current position identifying program, and map information retrieved from the magnetic disc 305 or the optical disc 307. Further, the manner of guidance at a left/right-turn point is determined based on the cost information concerning the alternative route when the mobile object misses the turn. The route guidance information generated by the execution of the route guidance program is output to the audio I/F 308 or the video I/F 312 through the CPU 301.

The sound generation program causes the navigation apparatus to generate information concerning tones and sounds corresponding to sound patterns. Based on the route guidance information generated by the execution of the route guidance program, the sound generation program causes the navigation apparatus to set a virtual source and generate audio guidance information corresponding to a guidance point. The audio guidance information includes, for example, an alarm indicating that the driver should turn left or right at the left/right-turn point, an alarm indicating that the driver should slow down before the left/right-turn point, information concerning an alternative route for a case where the driver misses the turn, and advisory information that advises the driver to go back when the turn is missed. The audio guidance information is output to the audio I/F 308 through the CPU 301.

The map information display program causes the navigation apparatus to display map information retrieved from the magnetic disc 305 or the optical disc 307 by the video I/F 312 on the display 313.

The magnetic disc drive 304 controls the reading/writing of data from/to the magnetic disc 305 under the control of the CPU 301. The magnetic disc 305 stores data written thereto under the control of the magnetic disc drive 304. The magnetic disc 305 may be an HD (hard disc) or FD (flexible disc).

The optical disc drive 306 controls the reading/writing of the data from/to the optical disc 307 under the control of the CPU 301. The optical disc 307 is a removal recording medium from which data is read under the control of the optical disc drive 306. The optical disc 307 may be a writable recording medium. The removal recording medium can be a medium other than the optical disc 307, such as an MO and a memory card.

One example of information stored on the magnetic disc 305 or the optical disc 307 is map information that is used for route retrieval, route guidance and so on. The map information includes background data representing features such as buildings, rivers, and ground surfaces, and road shape data representing shapes of roads, and is depicted two-dimensionally or three-dimensionally on the display 313.

The road shape data also includes traffic condition data. The traffic condition data includes, for example, information concerning the presence of a traffic light, a crosswalk, entrances/exits and junctions of expressways for nodes; lengths (distances), road widths, directions of travel, road types (expressway, toll road, general road) for links and so on.

Among the traffic condition data, information of past traffic congestion is stored as past traffic congestion information after statistical processing based on season, day of the week, long holiday seasons, the time of day, and so on. Although the navigation apparatus 300 acquires, for example, information concerning current traffic congestion from road traffic information received by the communication I/F 315 which is described later, the past traffic congestion information can be used to forecast congestion at a specified time of day, for example.

Although the map information is stored on the magnetic disc 305 or the optical disc 307 in this example, the invention is not limited to this example. The map information is stored not only in the constituent units integrally provided among the hardware of the navigation apparatus 300 but may be provided externally from the navigation apparatus 300. In this case, the navigation apparatus 300 may acquire the map information through the communication I/F 315 via a network. The map information acquired in this way is stored in the RAM 303, for example.

The audio I/F 308 is connected to the microphone 309 for audio input and the speaker 310 for audio output. Sounds received by the microphone 309 are A/D-converted within the audio I/F 308. The speaker 310 outputs sounds. Sounds input from the microphone 309 can be stored as audio data on the magnetic disc 305 or the optical disc 307.

The input device 311 includes a remote controller, a keyboard, a mouse, a touch panel and so on that are equipped with keys for entering characters, numeric values and various instructions.

The video I/F 312 is connected to the display 313 and the camera 314. The video I/F 312 is made up of, for example, a graphic controller that controls the display 313, a buffer memory such as VRAM (Video RAM) that temporarily stores immediately displayable image information, and a control IC that controls the display 313 based on image data output from the graphic controller.

The display 313 displays icons, cursors, menus, windows, or various data such as text and images. A CRT, a TFT liquid crystal display, a plasma display and so on can be employed as the display 313. The display 313 may be plural. For example, one display is mounted for a driver and one display is mounted for backseat passengers.

The camera 314 captures images of the inside or outside of the vehicle. An image may be a still image or a moving image. For example, the camera 314 captures the behavior of passengers inside of the vehicle and the images thereof are output via the video I/F 312 to the CPU 301 or a recording medium such as the magnetic disc 305 or the optical disc 307.

The camera 314 may capture the outside of the vehicle and the images thereof are output via the video I/F 312 to a recording medium such as the magnetic disc 305 or the optical disc 307. The images output to the CPU 301 are, for example, used for the determination of specific behavior of the passengers. The images output to a recording medium are used as images for a drive recorder and are overwritten.

The communication I/F 315 wirelessly communicates with a network and serves as an interface between the navigation apparatus 300 and the CPU 301. Further, the communication I/F 315 communicates with a system of networks such as the Internet and also serves as an interface between the system of networks and the CPU 301. The communication I/F 315 receives TV broadcasts and radio broadcasts.

The system of networks includes a LAN, a WAN, a public line network, a mobile telephone network and so on. Specifically, the communication I/F 315 is made up of, for example, an FM tuner, a VICS (Vehicle Information and Communication System)/beacon receiver, a radio navigation apparatus, and other navigation devices, and acquires the road traffic information concerning congestion and traffic regulations that are distributed from VICS centers. The VICS is a registered trademark.

The GPS unit 316 receives signals from GPS satellites and outputs information indicating the current position of the vehicle. The information output by the GPS unit 316 is used along with output values of the various sensors 317 described later in order for the CPU 301 to identify the current position of the vehicle. The information indicating the current position is information such as latitude, longitude, and altitude that specifies one point on a map.

The various sensors 317 output information that can be used to determine the location and behavior of the vehicle, such as a car speed sensor, an acceleration sensor, and an angular speed sensor. Values output by the various sensors 416 are used for the CPU 301 to specify the current position of the vehicle or measure the variation in the velocity or the direction.

The computing unit 103 and the determining unit 104 of the route guidance apparatus 100 of the present embodiment can be implemented by the CPU 301. The detecting unit 101 and the searching unit 102 can be implemented by the GPS unit 316 and the route guidance program stored in the ROM 302. The output unit 105 can be implemented by the audio generation program stored in the ROM 302, the audio I/F 308, the speaker 310, the video I/F 312 and the display 313. The measuring unit 106 can be implemented by the various sensors 317.

(Route Guidance Process of Navigation Apparatus)

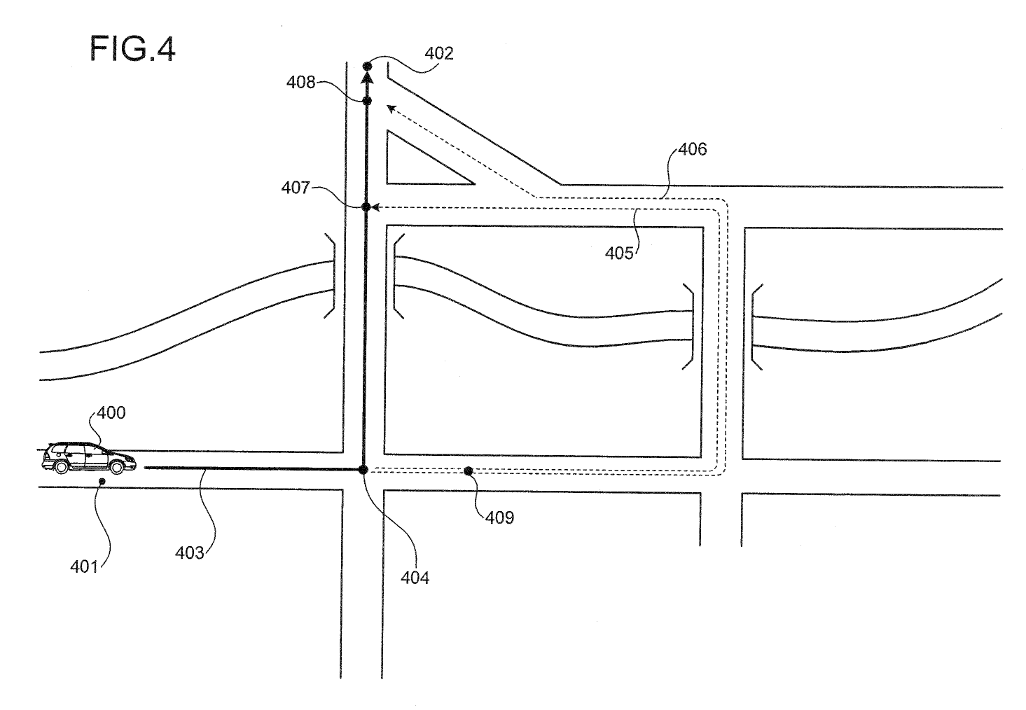

A situation where a vehicle equipped with the navigation apparatus 300 is traveling along a set route is explained. FIG. 4 is a diagram depicting one example of a situation where a vehicle equipped with a navigation apparatus according to the exemplary embodiment is traveling on the set route. As shown in FIG. 4, a vehicle 400 equipped with the navigation apparatus 300 is at a point 401 and is heading toward a destination 402.

A route 403 has been set as a set route by the navigation apparatus 300. A point 404 is a left-turn point (“left-turn point 404” hereinafter) on the route 403 where the vehicle 400 should turn left. A route 405 and a route 406 are candidates for alternative routes toward the destination 402 in preparation for a case where the vehicle 400 misses the left turn at the left turn point 404.

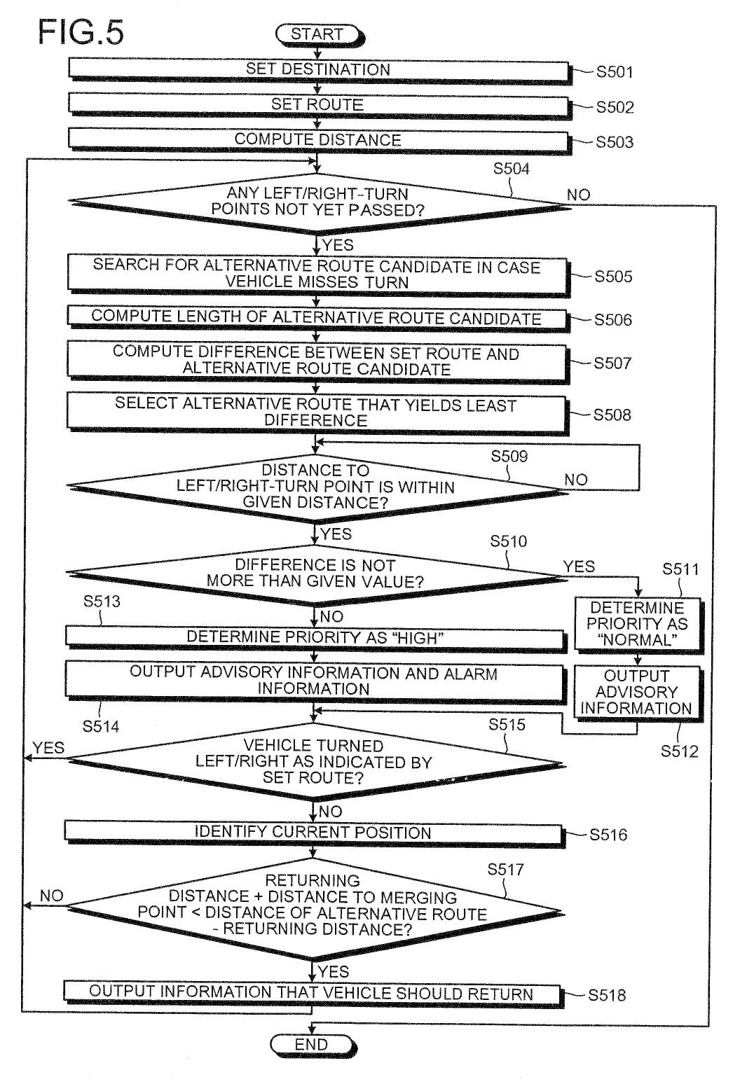

A route guidance process of the navigation apparatus 300 under the circumstance depicted in FIG. 4 is explained. FIG. 5 is a flowchart of one example of the route navigation process of the navigation apparatus. The input device 311 is manipulated by a user, and a destination is set (step S501). The GPS unit 316 sets a route to the destination 402 (step S502).

On the route 403 (hereinafter “set route”) set at step S502, the distance between the current position 401 of the vehicle 400 and the destination 402 (step S503) is computed. It is checked whether there are left/right-turn points through which the vehicle 400 has not yet passed on the route 403 (step S504). If all left/right-turn points have been passed through (step S504: NO), the process is terminated.

If the result at step S504 is that there are still left/right-turn points that have not yet been passed (step S504: YES), the alternative routes 405 and 406 are retrieved being candidates for an alternative route in case the vehicle 400 misses the turn at the left-turn point 404 (step S505). Under the circumstances depicted in FIG. 4, since the left-turn point 404 at which the vehicle 400 should turn left exists on a route which the vehicle 400 is following, it is determined that there is a left/right-turn point that has not yet been passed.

The length of each alternative route candidate is computed (step S506). Under the circumstances depicted in FIG. 4, the length of each of the alternative route 405 and 406 is computed. The difference between the length of the set route and the length of each candidate for alternative route obtained at step S506 is computed (step S507). Under the circumstances depicted in FIG. 4, the difference is computed between the length of a segment of the set route 403 from the left-turn point 404 to a merging point 407 where the set route 403 meets the alternative route 405 and the length of the alternative route 405 from the left-turn point 404, a starting point, to the merging point 407.

Further, the difference is computed between the length of a segment of the set route from the left-turn point 404 to a merging point 408 where the set route 403 meets the alternative route 406 and the length of the alternative route 406 from the left-turn point 404, a starting point, to the merging point 408. From among the candidates, the alternative route that yields the least difference among the differences computed at step s507 is selected (step S508). Under the circumstances depicted in FIG. 4, the route 406 is selected.

Waiting occurs until the vehicle 400 is within a predetermined distance from the left-turn point 404 (step S509: NO). When the distance between the vehicle 400 and the left-turn point 404 is within the predetermined distance (step S509: YES), it is determined whether the difference between the length of the set route and the length of the alternative route selected at step S508 is not more than a give value (step S510). If the difference between the length of the set route and that of the alternative route is not more than the given value (step S510: YES), the degree of importance of the left/right-turn point is determined as “normal” (step S511) and advisory information indicating that the driver should make a left/right turn is output (step S512), the flow proceeding to step S515.

If it is determined at step S510 that the difference between the length of the set and that of the alternative route is more than the given value (step S510: NO), the degree of importance of the left/right-turn point is determined as “high” (step S513), and advisory information is output indicating that the driver should make a left/right turn and will have to take a detour if the turn is missed (step S514). In the explanation above, step S509 precedes steps S510, S511, S513 but step S509 may be performed after steps S513 and S511. In other words, after steps S513 and S511, it is determined whether the distance between the vehicle and the left/right-turn point is within the given distance. If it is determined after step S513 that the distance is within the given distance, the flow goes to step S514. If it is determined after step S511 that the distance is within the given distance, the flow goes to step S512. If the distance is not within the given distance, step S509 is repeated until the distance is within the given distance.

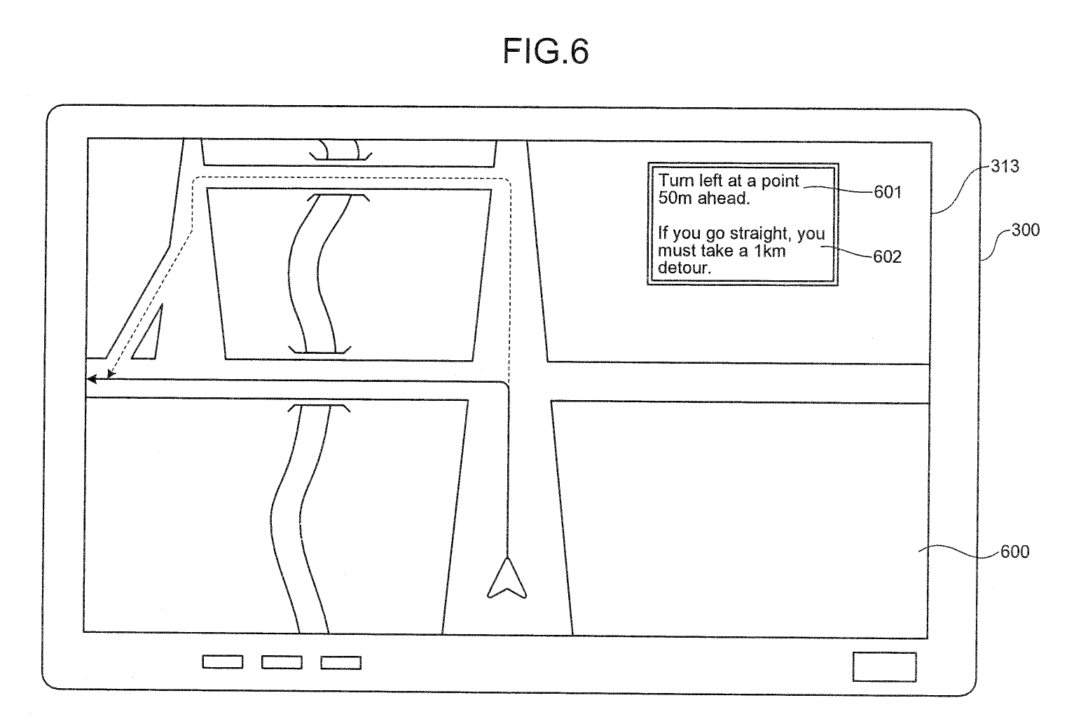

A situation is explained where the display 313 displays, at step S514, advisory information concerning a left/right turn and alarm information concerning a detour in the case of missing the turn. FIG. 6 is a diagram depicting a situation where the navigation apparatus outputs advisory information concerning a left/right turn and alarm information to the display. The display 313 of the navigation apparatus 300 displays a guide map 600 for route guidance together with turn guidance information 601 indicating that the vehicle should turn left/right and alarm information 602 indicating that the vehicle will have to take a detour if the turn is missed. The display 313 displays, for example, “Turn left at a point 50 m ahead. If you go straight, you must take a 1 km detour” as shown in FIG. 6.

The explanation of the flowchart is continued. It is determined whether the vehicle 400 has turned left/right at the left-turn point 404 as indicated by the set route 403 (step S515). Under the circumstances shown in FIG. 4, it is determined whether the vehicle 400 has turned left at the left-turn point 404. If it is determined that the vehicle has turned left at the left-turn point 404 (step S515: YES), the flow returns to step S504 and the route guidance continues. If it is determined that the vehicle has not turned left at the left-turn point 404 (step S515: NO), the current position of the vehicle 40 is identified (step S516). It is assumed here that the identified current position is a point 409 in FIG. 4.

It is determined whether the sum of the length of a route going back to the left-turn point 404 from the current position 409 (hereinafter “returning distance”) and the length of a route on the set route 403 from the left-turn point 404 to the merging point is smaller than the length of a segment of the alternative route less the returning distance (step S517). If it is determined that the sum is not smaller (step S517: NO), the flow returns to the step S504 and the route guidance continues.

If it is determined at step S517 that the sum is smaller (step S517: YES), guidance is output indicating that the vehicle should return to the left-turn point 404 (step S518), and the flow returns to step S504 and the route guidance continues. Instead of considering the difference between the length of the alternative route and the length of a route of turning back, it may be determined whether the difference is more than a predetermined value. Even if the length of a route of turning back is less, it is possible that the difference is so slight that the vehicle is better off continuing to follow the alternative route in light of the time loss for a U-turn. Therefore, guidance indicating that the vehicle should go back may be output only when the difference is more than the predetermined value. The determination whether a place suitable for the vehicle to turn around, to make a U-turn, exists may also be taken into consideration. In this case, it is determined whether a proper place for the vehicle (for example, a parking lot) to turn around exists near the current position 409. If such a place does not exist, guidance information indicating that the vehicle should follow the alternative route is output. If such a place exists, it is determined whether the sum of the length of a route from the current position to that place, the length of a route from that place to the left-turn point 404, and the length of a route from the left-turn point 404 to the merging point where the set route meets the alternative route 406 is smaller than the length of a segment of the alternative route less the returning distance.

As set forth above, according to the navigation apparatus of the above example, the degree of importance of a left/right-turn point is determined before a vehicle passes the left/right-turn point, and alarm information concerning the left/right-turn point can be output based on the degree of importance. Therefore, a driver can drive especially carefully at a left/right-turn point having a high degree of importance.

The route guidance method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

1-12. (canceled)

13. A route guidance apparatus comprising:
a detecting unit that detects from a set route, a left/right-turn point that a vehicle has not passed;
a searching unit that searches for an alternative route before the vehicle passes the left/right-turn point in case the vehicle does not turn at the left/right-turn point;
a computing unit that computes cost information concerning the alternative route and cost information concerning a direct route on the set route from the left/right-turn point to a merging point where the set route and the alternative route meet;
a determining unit that determines a degree of importance of the left/right-turn point based on the cost information computed by the computing unit; and
an output unit that based on the degree of importance determined by the determining unit, outputs alarm information before the mobile object passes the left/right-turn point, the alarm information concerning the left/right-turn point.

14. The route guidance apparatus according to claim 13, wherein the output unit, when the degree of importance determined by the determining unit is more than or equal to a given value, outputs first alarm information before the vehicle passes the left/right-turn point, the first alarm information concerning the left/right-turn point.

15. The route guidance apparatus according to claim 14, further comprising a measuring unit that, when the degree of importance determined by the determining unit is more than or equal to the given value, measures a velocity of the vehicle before the vehicle passes the left/right-turn point, wherein
the output unit, when the velocity measured by the measuring unit exceeds a predetermined velocity, outputs second alarm information before the vehicle passes the left/right-turn point, the second alarm information advising the vehicle to slow down.

16. The route guidance apparatus according to claim 13, further comprising:
a left/right-turn judging unit that judges whether the vehicle has turned at the left/right-turn point according to the set route; and
an identifying unit that identifies a current position of the vehicle if the left/right-turn judging unit judges that the vehicle has not turned at the left/right-turn point according to the set route, wherein
the computing unit computes cost information concerning a non-returning route along the alternative route from the current position to the merging point, and cost information concerning a returning route along the alternative route from the current position to the left/right-turn point,
the determining unit determines a route from the current position to the merging point based on the cost information concerning the non-returning route and total cost information indicative of the cost information concerning the returning route plus the cost information concerning the direct route, and
the output unit outputs advisory information that is based on a determination result by the determining unit and that indicates whether the vehicle should turn back to the left/right-turn point.

17. A route guidance method comprising:
a detecting step of detecting from a set route, a left/right-turn point that a vehicle has not passed;
a searching step of searching for an alternative route before the vehicle passes the left/right-turn point in case the vehicle does not turn at the left/right-turn point;
a computing step of computing cost information concerning the alternative route and cost information concerning a direct route on the set route from the left/right-turn point to a merging point where the set route and the alternative route meet;
a determining step of determining a degree of importance of the left/right-turn point based on the cost information computed at the computing step; and
an output step of outputting based on the degree of importance determined by the determining unit, alarm information before the mobile object passes the left/right-turn point, the alarm information concerning the left/right-turn point.

18. The route guidance method according to claim 17, wherein the outputting includes, when the degree of importance determined at the determining step is more than or equal to a given value, outputting first alarm information before the vehicle passes the left/right-turn point, the first alarm information concerning the left/right-turn point.

19. The route guidance method according to claim 17, further comprising a measuring step of measuring, when the degree of importance determined at the determining step is more than or equal to the given value, a velocity of the vehicle before the vehicle passes the left/right-turn point, wherein
the outputting, when the velocity measured at the measuring step exceeds a predetermined velocity, includes outputting second alarm information before the vehicle passes the left/right-turn point, the second alarm information advising the vehicle to slow down.

20. The route guidance method according to claim 17, further comprising:
a left/right-turn judging step of judging whether the vehicle has turned at the left/right-turn point according to the set route; and
an identifying step of identifying a current position of the vehicle if at the left/right-turn judging step, the vehicle is judged not to have turned at the left/right-turn point according to the set route, wherein
the computing step includes computing cost information concerning a non-returning route along the alternative route from the current position to the merging point, and cost information concerning a returning route along the alternative route from the current position to the left/right-turn point,
the determining step includes determining a route from the current position to the merging point based on the cost information concerning the non-returning route and total cost information indicative of the cost information concerning the returning route plus the cost information concerning the direct route, and
the outputting step includes outputting advisory information that is based on a determination result at the determining step of determining the route and that indicates whether the vehicle should turn back to the left/right-turn point.

21. A computer-readable recording medium storing therein a route-guidance computer program that causes a computer to execute:
a detecting step of detecting from a set route, a left/right-turn point that a vehicle has not passed;
a searching step of searching for an alternative route before the vehicle passes the left/right-turn point in case the vehicle does not turn at the left/right-turn point;
a computing step of computing cost information concerning the alternative route and cost information concerning a direct route on the set route from the left/right-turn point to a merging point where the set route and the alternative route meet;
a determining step of determining a degree of importance of the left/right-turn point based on the cost information computed at the computing step; and
an output step of outputting based on the degree of importance determined by the determining unit, alarm information before the mobile object passes the left/right-turn point, the alarm information concerning the left/right-turn point.

22. A route guidance apparatus comprising:
a detecting unit that detects from a set route, a given point that a vehicle has not passed;
a searching unit that searches for an alternative route before the vehicle passes the given point in case the vehicle does not pass the given point according to the set route;
a computing unit that computes cost information concerning the alternative route; and
an output unit that outputs, based on the cost information computed by the computing unit, alarm information concerning the given point before the mobile object passes the given point.

23. A route guidance method comprising:
a detecting step of detecting from a set route, a given point that a vehicle has not passed;
a searching step of searching for an alternative route before the vehicle passes the given point in case the vehicle does not pass the given point according to the set route;
a computing step of computing cost information concerning the alternative route; and
an output step of outputting, based on the cost information computed by the computing unit, alarm information concerning the given point before the mobile object passes the given point.
